(19) United States
(12) Patent Application Publication
(10) Pub. No.: US 2023/0403218 A1
(43) Pub. Date: Dec. 14, 2023

(54) STATE CONSISTENCY MONITORING FOR PLANE-SEPARATION ARCHITECTURES

(71) Applicant: VMware, Inc., Palo Alto, CA (US)

(72) Inventors: Xi CHENG, Beijing (CN); Caixia JIANG, Beijing (CN); Dongrui MO, Beijing (CN); Yahao HE, Beijing (CN); Qiong WANG, Beijing (CN)

(73) Assignee: VMware, Inc., Palo Alto, CA (US)

(21) Appl. No.: 17/875,386

(22) Filed: Jul. 27, 2022

(30) Foreign Application Priority Data
Jun. 8, 2022 (WO) PCT/CN2022/097519

(51) Int. Cl. H04L 43/0817; H04L 43/065; H04L 41/0604

(52) U.S. Cl. CPC H04L 43/0817; H04L 43/065; H04L 41/0627

(57) ABSTRACT

Example methods and systems for state consistency monitoring in a network environment are described. In one example, a computer system may identify association chain(s) that associate (a) first state information associated with one or more first network entities residing on a first plane with (b) second state information associated with one or more second network entities residing on a second plane. Based on the association chain(s), a consistency check may be performed to compare multiple first fields of the first state information with multiple second fields of the second state information. In response to determination that there is a state inconsistency based on the consistency check, a remediation action to address the state inconsistency by generating and sending at least one of the following: a notification to a user, and a remediation request to a particular first network entity residing on the first plane or a particular second network entity residing on the second plane.

### CROSS-REFERENCE TO RELATED APPLICATION

The present application claims the benefit of Patent Cooperation Treaty (PCT) Application No. PCT/CN2022/097519, filed Jun. 8, 2022, which is incorporated herein by reference.

### BACKGROUND

Virtualization allows the abstraction and pooling of hardware resources to support virtual machines in a Software-Defined Networking (SDN) environment, such as a Software-Defined Data Center (SDDC). For example, through server virtualization, virtualization computing instances such as virtual machines (VMs) running different operating systems may be supported by the same physical machine (e.g., referred to as a “host”). Each VM is generally provisioned with virtual resources to run an operating system and applications. The virtual resources may include central processing unit (CPU) resources, memory resources, storage resources, network resources, etc. Using a plane separation architecture, the SDN environment may be divided into multiple planes having different functionalities. In practice, state inconsistencies between different planes may lead to incorrect network behavior, which is undesirable and affects network performance.

### BRIEF DESCRIPTION OF DRAWINGS

FIG. 1 is a schematic diagram illustrating an example network environment in the form of a software-defined networking (SDN) environment in which state consistency monitoring may be performed;

FIG. 2 is a schematic diagram illustrating an example computer system to perform state consistency monitoring in a network environment with a plane separation architecture;

FIG. 3 is a flowchart of an example process for a computer system to perform state consistency monitoring for a plane separation architecture;

FIG. 4 is a schematic diagram illustrating an example plane separation architecture for which state consistency monitoring may be performed;

FIG. 5 is a flowchart of an example detailed process for a computer system to perform state consistency monitoring for a plane separation architecture;

FIG. 6 is a schematic diagram illustrating a first example of state consistency monitoring for a control plane and a data plane;

FIG. 7 is a schematic diagram illustrating a first example of state consistency monitoring for a local control plane and a data plane; and

FIG. 8 is a schematic diagram illustrating experimental evaluation results associated with state consistency monitoring.

### DETAILED DESCRIPTION

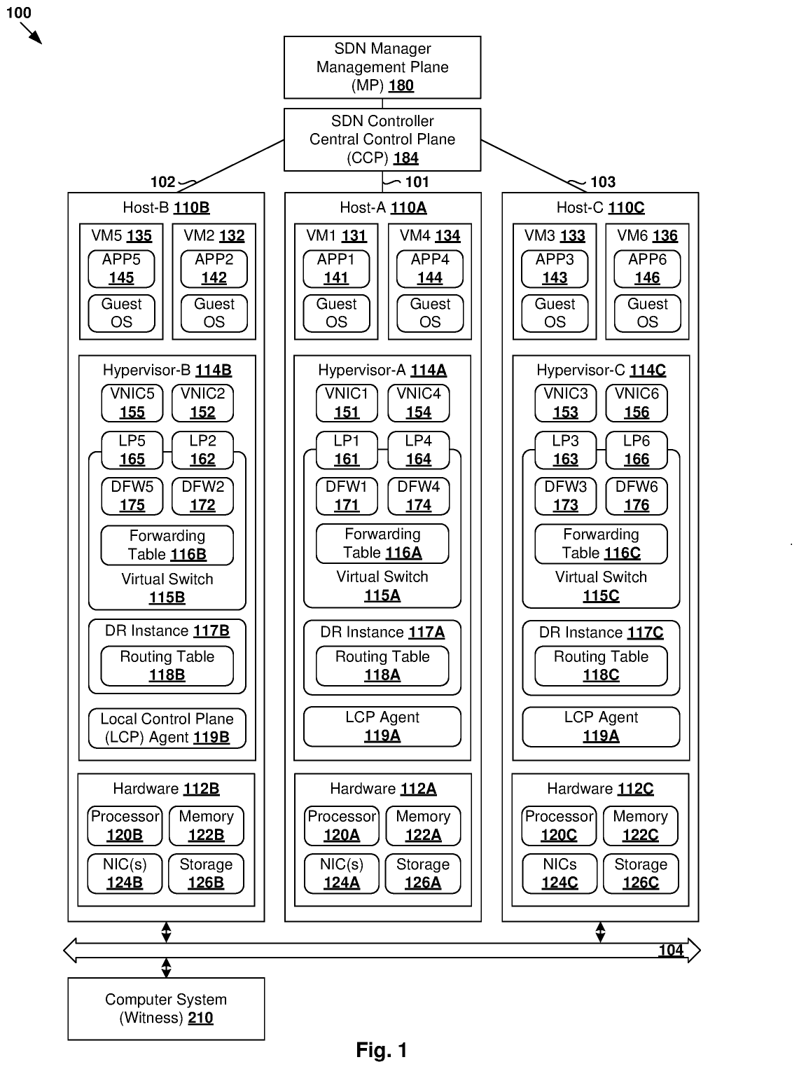

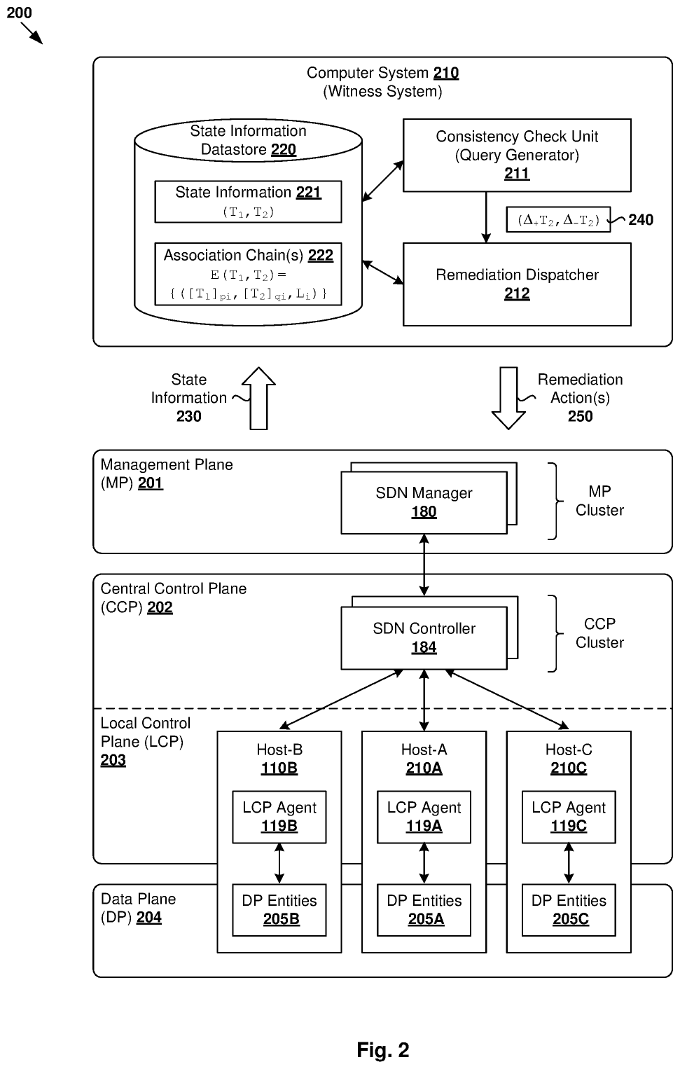

According to examples of the present disclosure, state consistency monitoring may be implemented to detect state inconsistencies that may lead to incorrect network behavior(s) in a network environment with plane separation architecture. One example may involve a computer system (e.g., witness system 210 in FIGS. 1-2) identifying association chain(s) that associate (a) first state information of one or more first network entities residing on a first plane (e.g., control plane 202/203 in FIG. 2) with (b) second state information of one or more second network entities residing on a second plane (e.g., data plane 204 in FIG. 2). Based on the association chain(s), the computer system may perform a consistency check to compare multiple first fields of the first state information with multiple second fields of the second state information. Based on the consistency check, the computer system may determine whether there is a state inconsistency between the first plane and the second plane. In response to determination that there is a state inconsistency, a remediation action to address the state inconsistency may be performed by generating and sending at least one of the following: a notification to a user, and a remediation request to a particular first network entity residing on the first plane or a particular second network entity residing on the second plane. See also 220-250 in FIG. 2.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein. Although the terms “first” and “second” are used to describe various elements, these elements should not be limited by these terms. These terms are used to distinguish one element from another. For example, a first element may be referred to as a second element, and vice versa.

FIG. 1 is a schematic diagram illustrating an example network environment in the form of software-defined networking (SDN) environment 100 in which state consistency monitoring may be performed. Depending on the desired implementation, SDN environment 100 may include additional and/or alternative components than that shown in FIG. 1. SDN environment 100 includes multiple hosts 110A-C that are inter-connected via physical network 104. In practice, SDN environment 100 may include any number of hosts (also known as a “host computers”, “host devices”, “physical servers”, “server systems”, “transport nodes,” etc.). Each host may be supporting tens or hundreds of virtual machines (VMs). It should be understood that examples of the present disclosure may be implemented in any suitable network environment(s) with plane separation architecture, either SDN or non-SDN network environment(s).

Each host 110A/110B/110C may include suitable hardware 112A/112B/112C and virtualization software (e.g., hypervisor-A 114A, hypervisor-B 114B, hypervisor-C 114C) to support various VMs. For example, hosts 110A-C may support respective VMs 131-136 (see also FIG. 2). Hypervisor 114A/114B/114C maintains a mapping between underlying hardware 112A/112B/112C and virtual resources allocated to respective VMs. Hardware 112A/112B/112C includes suitable physical components, such as central processing unit(s) (CPU(s)) or processor(s) 120A/120B/120C; memory 122A/122B/122C; physical network interface controllers (NICs) 124A/124B/124C; and storage disk(s) 126A/126B/126C, etc.

Virtual resources are allocated to respective VMs 131-136 to support a guest operating system (OS) and application(s). For example, VMs 131-136 support respective applications 141-146 (see “APP1” to “APP6”). The virtual resources may include virtual CPU, guest physical memory, virtual disk, virtual network interface controller (VNIC), etc. Hardware resources may be emulated using virtual machine monitors (VMMs). For example in FIG. 1, VNICs 151-156 are virtual network adapters for VMs 131-136, respectively, and are emulated by corresponding VMMs (not shown for simplicity) instantiated by their respective hypervisor at respective host-A 110A, host-B 110B and host-C 110C. The VMMs may be considered as part of respective VMs, or alternatively, separated from the VMs. Although one-to-one relationships are shown, one VM may be associated with multiple VNICs (each VNIC having its own network address).

Although examples of the present disclosure refer to VMs, it should be understood that a “virtual machine” running on a host is merely one example of a “virtualized computing instance” or “workload.” A virtualized computing instance may represent an addressable data compute node (DCN) or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc. Such container technology is available from, among others, Docker, Inc. The VMs may also be complete computational environments, containing virtual equivalents of the hardware and software components of a physical computing system.

The term “hypervisor” may refer generally to a software layer or component that supports the execution of multiple virtualized computing instances, including system-level software in guest VMs that supports namespace containers such as Docker, etc. Hypervisors 114A-C may each implement any suitable virtualization technology, such as VMware ESX® or ESXi™ (available from VMware, Inc.), Kernel-based Virtual Machine (KVM), etc. The term “packet” may refer generally to a group of bits that can be transported together, and may be in another form, such as “frame,” “message,” “segment,” etc. The term “traffic” or “flow” may refer generally to multiple packets. The term “layer-2” may refer generally to a link layer or media access control (MAC) layer; “layer-3” to a network or Internet Protocol (IP) layer; and “layer-4” to a transport layer (e.g., using Transmission Control Protocol (TCP), User Datagram Protocol (UDP), etc.), in the Open System Interconnection (OSI) model, although the concepts described herein may be used with other networking models. There are two versions of IP: IP version 4 (IPv4) and IP version 6 (IPv6) that will be discussed below.

Hypervisor 114A/114B/114C implements virtual switch 115A/115B/115C and logical distributed router (DR) instance 117A/117B/117C to handle egress packets from, and ingress packets to, corresponding VMs. In SDN environment 100, logical switches and logical DRs may be implemented in a distributed manner and can span multiple hosts. For example, logical switches that provide logical layer-2 connectivity, i.e., an overlay network, may be implemented collectively by virtual switches 115A-C and represented internally using forwarding tables 116A-C at respective virtual switches 115A-C. Forwarding tables 116A-C may each include entries that collectively implement the respective logical switches. Further, logical DRs that provide logical layer-3 connectivity may be implemented collectively by DR instances 117A-C and represented internally using routing tables 118A-C at respective DR instances 117A-C. Routing tables 118A-C may each include entries that collectively implement the respective logical DRs.

Packets may be received from, or sent to, each VM via an associated logical port. For example, logical switch ports 161-166 (see “LP1” to “LP6”) are associated with respective VMs 131-136. Here, the term “logical port” or “logical switch port” may refer generally to a port on a logical switch to which a virtualized computing instance is connected. A “logical switch” may refer generally to an SDN construct that is collectively implemented by virtual switches 115A-C in FIG. 1, whereas a “virtual switch” may refer generally to a software switch or software implementation of a physical switch. In practice, there is usually a one-to-one mapping between a logical port on a logical switch and a virtual port on virtual switch 115A/115B/115C. However, the mapping may change in some scenarios, such as when the logical port is mapped to a different virtual port on a different virtual switch after migration of a corresponding virtualized computing instance (e.g., when the source host and destination host do not have a distributed virtual switch spanning them).

To protect VMs 131-136 against security threats caused by unwanted packets, hypervisors 114A-C may implement firewall engines to filter packets. For example, distributed firewall engines 171-176 (see “DFW1” to “DFW6”) are configured to filter packets to, and from, respective VMs 131-136 according to firewall rules. In practice, network packets may be monitored and filtered according to firewall rules at any point along a datapath from a VM to corresponding physical NIC 124A/124B/124C. In one embodiment, a filter component (not shown) is incorporated into each VNIC 151-156 that enforces firewall rules that are associated with the endpoint corresponding to that VNIC and maintained by respective distributed firewall engines 171-176.

Through virtualization of networking services in SDN environment 100, logical networks (also referred to as overlay networks or logical overlay networks) may be provisioned, changed, stored, deleted and restored programmatically without having to reconfigure the underlying physical hardware architecture. A logical network may be formed using any suitable tunneling protocol, such as Virtual eXtensible Local Area Network (VXLAN), Stateless Transport Tunneling (STT), Generic Network Virtualization Encapsulation (GENEVE), etc. For example, VXLAN is a layer-2 overlay scheme on a layer-3 network that uses tunnel encapsulation to extend layer-2 segments across multiple hosts which may reside on different layer 2 physical networks.

SDN manager 180 and SDN controller 184 are example network management entities in SDN environment 100. One example of an SDN controller is the NSX controller component of VMware NSX® (available from VMware, Inc.) that operates on a central control plane. SDN controller 184 may be a member of a controller cluster (not shown for simplicity) that is configurable using SDN manager 180, which may be part of a manager cluster operating on a management plane. Network management entity 180/184 may be implemented using physical machine(s), VM(s), or both. Logical switches, logical routers, and logical overlay networks may be configured using SDN controller 184, SDN manager 180, etc. To send or receive control information, a local control plane (LCP) agent 119A/119B/119C on host 110A/110B/110C may interact SDN controller 184 via control-plane channel 101A/101B/101C.

Hosts 110A-C may also maintain data-plane connectivity among themselves via physical network 104 to facilitate communication among VMs located on the same logical overlay network. Hypervisor 114A/114B/114C may implement a virtual tunnel endpoint (VTEP) (not shown) to encapsulate and decapsulate packets with an outer header identifying the relevant logical overlay network (e.g., using a VXLAN or “virtual” network identifier (VNI) added to a header field). For example in FIG. 1, hypervisor-A 114A implements a first VTEP associated with (IP address=IP-A, MAC address=MAC-A, VTEP label=VTEP-A), hypervisor-B 114B implements a second VTEP with (IP-B, MAC-B, VTEP-B), hypervisor-C 114C implements a third VTEP with (IP-C, MAC-C, VTEP-C), etc. Encapsulated packets may be sent via an end-to-end, bi-directional communication path (known as a tunnel) between a pair of VTEPs over physical network 104.

Plane Separation Architecture

FIG. 2 is a schematic diagram illustrating example computer system 210 to perform state consistency monitoring in network environment 100 with plane separation architecture 200. In this example, network environment 100 may be divided into multiple network planes, such as management plane (MP) 201, central control plane (CCP) 202, local control plane (LCP) 203 and data plane 204. Any suitable network entity or entities may reside on each plane. For example, SDN manager(s) 180 may reside on MP 201 and a cluster of SDN controller(s) 184 on CCP 202. Further, on hosts 110A-C, respective LCP agents 119A-C may reside on LCP 203, and data plane entities 205A-C on DP 204.

As used herein, the term “control plane” may refer generally to functions that manage the intents of network administrators, maintain the desired network topology, and define traffic routing. Depending on the desired implementation, the control plane may include both CCP 202 and LCP 203. The term “management plane” may refer generally to functions relating to management of various planes 201-204, including providing user interface(s) for managing and configuring various network entities, troubleshooting, diagnosis, etc. The term “data plane” may refer generally to functions that handle traffic forwarding along a datapath between two endpoints (e.g., VM1 131 on host-A 110A and VM2 132 on host-B 110B). Data plane entities 205A-C may include physical and/or logical forwarding entities (also known as “forwarders”), such as physical/logical port(s), physical/logical switch(es), physical/logical router(s), VNIC(s), PNIC(s), edge appliance(s), etc. In practice, an edge appliance may be a transport node that resides on both LCP 203 and DP 204. It should be noted that DP 204 may include network services, such as firewall, load balancer, service insertion, etc. These network services may be distributed services implemented by hypervisor 114A/114B/114C and/or centralized services implemented by an edge appliance.

In relation to control-data plane separation, for example, there are various technical benefits for its implementation. First, the network may be managed in a centralized manner, which reduces if not eliminates the complexity in configuring a network entity locally with awareness of configurations and states of adjacent network entities. Second, it allows the control plane and data plane to evolve and be developed independently, which provides better vendor neutrality and interoperability across the network. The control-data plane separation architecture has been widely adopted in various computer systems (i.e., not limited to SDN environment 100). In a simplified perspective, interactions between control and data planes may include (1) reporting realized state from the data plane to the control plane, and (2) enforcing desired states (which include user's intents and realized states of surrounding network entities) from the control plane to the data plane.

In practice, state inconsistency or discrepancy between two planes (e.g., control plane and data plane) may occur due to various reasons, such as communication errors, software issues, etc. Any discrepancy is undesirable because it may lead to incorrect behavior in SDN environment 100. Some major challenges in addressing such issues are summarized below. First, many of the issues may only be manifested with specific configurations and workloads. Second, the occurrence patterns of these issues are usually demonstrated as irregular and unpredictable before root causes are known, which makes it difficult to apply workarounds and/or collect necessary debugging information in a timely manner. Third, in some cases, workarounds may be unavailable and cause users to temporarily make changes on network design or wait for a fix, which substantially hinders user experience. As such, state inconsistencies are undesirable in SDN environment.

State Consistency Monitoring

According to examples of the present disclosure, state consistency monitoring may be performed detect state inconsistencies that may lead to incorrect network behavior(s) in a network environment (i.e., not limited to an SDN environment) with multiple planes. As used herein, the term “plane” or “network plane” may refer generally to a logical division of a network environment with an architecture that is logically divided or separated into multiple divisions. Each plane may be associated with one or more network entities residing on that plane, such as SDN manager(s) 180 residing on MP 201, SDN controller(s) 184 on CCP 202, LCP agents 119A-C on LCP 203 and physical/logical forwarding entities on DP 204 in FIG. 2.

Depending on the desired implementation, any suitable computer system may be deployed to perform state consistency monitoring, such as a centralized witness system (see 210 in FIGS. 1-2) that is able to interact with multiple planes 201-204 in SDN environment 100 with a plane separation architecture. In the example in FIG. 2, witness system 210 may include any suitable software and/or hardware components, such as (a) consistency check unit 211 (also known as a query generator) to detect state inconsistencies based on state information 221, (b) remediation dispatcher 212 to perform remediation action(s). State information 221 may be stored in datastore 220 (e.g., state database) accessible by consistency check unit 211 along with association chain(s) 222 to be discussed below. Witness system 210 may provide any suitable user interface(s) for users (e.g., network administrators) to configure state consistency monitoring and access any result(s), such as application programming interface (API), command-line interface (CLI), representational state transfer (REST) API, etc.

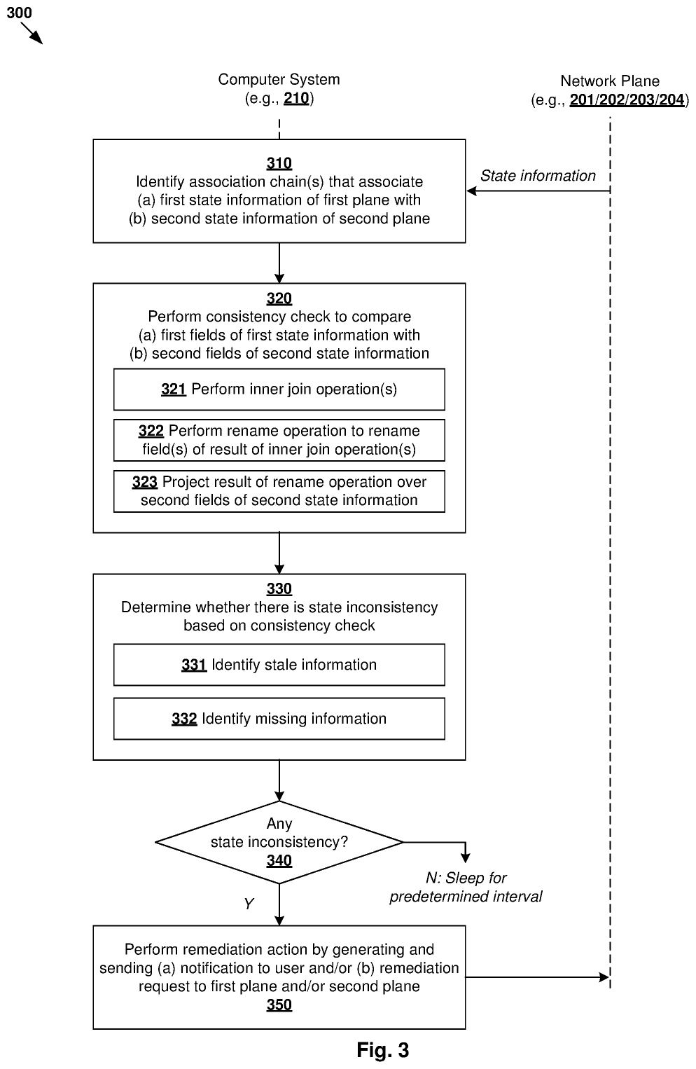

The example in FIG. 2 will be explained using FIG. 3, which is a flowchart of example process 300 for a computer system to perform state consistency monitoring. Example process 300 may include one or more operations, functions, or actions illustrated by one or more blocks, such as 310 to 350. Depending on the desired implementation, various blocks may be combined into fewer blocks, divided into additional blocks, and/or eliminated. Examples of the present disclosure may be implemented to perform state consistency monitoring for any suitable “first plane” and “second plane,” such as CCP 202 and DP 204, LCP 203 and DP 204, MP 201 and CCP 202, etc. Any additional and/or alternative plane(s) may be configured as desired.

At 310 in FIG. 3, witness system 210 may identify association chain(s) associating (a) first state information of first network entity or entities residing on the first plane with (b) second state information of second network entity or entities residing on the second plane. In practice, the term “state information” may refer generally to any suitable information accessible by a network entity to perform various functionalities, including configuration information, real-time information, etc. See 230 in FIG. 2.

As will be explained below, an “association chain” (denoted as Lᵢ) may identified from an equivalence specification that includes a set of equivalence targets. The equivalence specification may be denoted as {([T₁]ₚᵢ, [T₂]_{qi},Lᵢ)}. Here, each equivalence target ([T₁]ₚᵢ, [T₂]_{qi},Lᵢ) specifies (a) [T₁]ₚᵢ=particular first field (pi) of a first table (T₁) in the first state information, (b) [T₂]_{qi}=particular second field (pi) of a second table (T₂) in the second state information and (c) Lᵢ=association chain between [T₁]ₚᵢ and [T₂]_{qi}. The association chain (Lᵢ) may define a mapping or relationship (e.g., binary relation) between [T₁]ₚᵢ and [T₂]_{qi} via zero or more intermediate fields (e.g., a third field in a third table). The intermediate field(s) may be part of the first or second state information. See 221-222 in FIG. 2.

At 320 in FIG. 3, based on the association chain(s), witness system 210 may perform a consistency check to compare multiple first fields of the first state information (e.g., includes first table denoted as T₁) with multiple second fields of the second state information (e.g., includes second table denoted as T₁). Depending on the desired implementation, the consistency check may include performing inner join operation(s) between the first state information and the second state information. Further, the consistency check may include (a) performing a rename operation to rename field(s) of a result of the inner join operation(s), (b) generating a projected table by projecting a result of the rename operation over the multiple second fields of the second state information and (b) comparing the projected table with the second state information. See 321-323 in FIG. 3.

At 330 in FIG. 3, based on the consistency check, witness system 210 may determine whether there is a state inconsistency between the first plane and the second plane. In practice, block 330 may include identifying the state inconsistency using the first state information as a source of truth. In a first example, the state inconsistency may be stale information (denoted as Δ₊T₂) that is included in the second state information (T₂) but not in the first state information (T₁). In a second example, the state inconsistency may be missing information (denoted as Δ₋T₂) that is included in the first state information (T₁) but not in the second state information (T₂). See 240 in FIG. 2.

At 340 and 350 in FIG. 3, in response to determination that there is a state inconsistency, witness system 210 may perform a remediation action to address the state inconsistency. In one example, a notification may be generated and sent to a user (e.g., network administrator) to raise alarm on potential and/or upcoming system issues due to the state inconsistency. Alternatively or additionally, a remediation request may be generated and sent to a particular first network entity residing on the first plane and/or a particular second network entity residing on the second plane, or both. See also 250 in FIG. 2. For example, the remediation request may cause the particular second network entity to correct the state inconsistency, such as by removing/deleting stale information, adding missing information, etc. Through remediation action(s), the time to resolution (TTR) for system outage may be reduced.

Using examples of the present disclosure, state inconsistencies between two network planes may be identified automatically by witness system 210 in real time such that appropriate remediation action(s) may be performed to address the state inconsistencies. This way, network performance may be improved by reducing the likelihood of incorrect network behavior(s) and system downtime. For the purposes of quality engineering, examples of the present disclosure may help to proactively identify product issues related to state discrepancy between multiple planes.

In the following, various examples will be described using centralized witness system 210 that operates independently from various network planes 201-204. Depending on the desired implementation, any suitable computer system that is capable of interacting with network planes 201-204 and processing state information may be configured to perform examples of the present disclosure. State consistency monitoring may be performed periodically (e.g., user-configurable interval) such that state inconsistencies may be detected and addressed in a real-time manner.

Example Control-Data Plane Separation Architecture

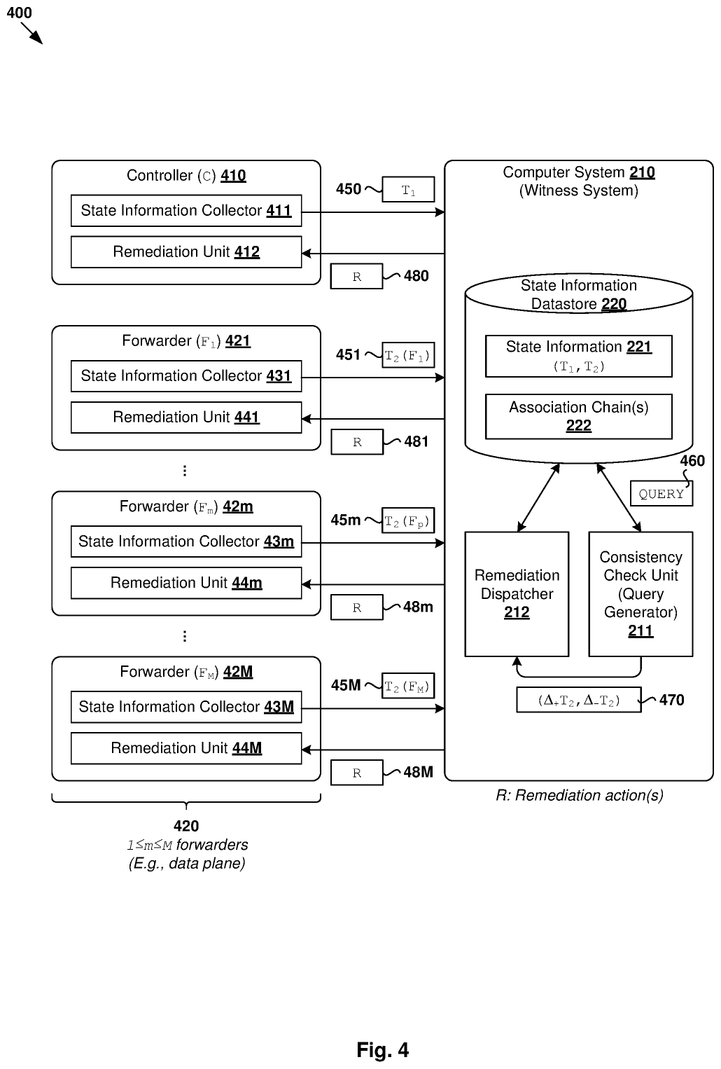

FIG. 4 is a schematic diagram illustrating example control-data plane separation architecture 400 in which state consistency monitoring may be performed. Although some examples are described using control plane and data plane below, it should be understood that the terms “first plane” and “second plane” may refer generally to a pair of network planes in a network environment with plane separation architecture. In this case, the terms “first network entity” and “second network entity” may refer generally to network entities residing on the respective “first plane” and “second plane.”

Similarly, the terms “first state information” and “second state information” may refer generally to state information associated with respective “first plane” and “second plane.” For example, first state information associated with CCP 202 or LCP 203 may be used as the source of truth of desired states, which are user intents and logical network configurations computed by controller(s). Second state information associated with DP 204 may be used as the source of runtime states, which are ephemeral states of network entities residing on DP 204.

In the example in FIG. 4, the functions of state consistency monitoring may span witness system 210, “first network entity” in the form of controller 410 (denoted as C) residing on a control plane (e.g., CCP 202 or LCP 203), and “second network entities” in the form of multiple (M) forwarders 421-42M residing on DP 204. Forwarders 421-42M may be collectively represented using reference numeral 420, and a particular forwarder (Fₘ) using 42m, where 1≤m≤M.

Controller 410 (denoted as C) on the control plane may include state collector 411 and remediation unit 412. State information collector 411 may be configured to collect state information 450 associated with controller 410, and remediation unit 412 to perform remediation action(s) based on notification(s) 480 from witness system 210. Similarly, each forwarder (Fₘ) 42m may include state information collector 43m and remediation unit 44m. Collector 43m may be configured to collect state information 45m associated with forwarder 42m, and remediation unit 43m to perform remediation action(s) based on notification(s) 48m from witness system 210. Each collector 411/43m may track state information using semantically equivalent state tables that are synchronized with state database 220 of witness system 210. In practice, any suitable number of controller and forwarder may be deployed.

State information associated with a network entity (i.e., controller 410 or forwarder 42m) may be formulated as state table(s). The schemas of state tables involved in consistency checking may be predefined by the system and/or user(s). For example, first state information 450 may include state table(s) denoted as T₁. Second state information 45m associated with each forwarder 42j may include state table(s) denoted as T₂(Fₘ), where Fₘ denotes the m^{th} forwarder and m∈[1, . . . , M]. In this case, state consistency monitoring for each pair of state tables (T₁, T₂).

Depending on the desired implementation, witness system 210 may be a centralized entity that includes (a) state database 220 to store state information, (b) consistency check unit 211 to perform state consistency monitoring by querying state database and (c) remediation dispatcher 212 to dispatch instruction(s) based on the result of state consistency monitoring. In practice, witness system 210 may be implemented as part of any suitable network intelligence platform, such as VMware NSX® Intelligence (available from VMware, Inc.), etc. This way, witness system 210 may (1) reuse the data processing infrastructure of the platform, as well as (2) operate independently from network entities (e.g., SDN manager 180, SDN controller 184 and transport nodes in the form of hosts 110A-C) to be monitored. Witness system 210 is applicable to any network environment that employs plane separation architecture.

For each pair of state tables (T₁, T₂), consistency check unit 211 (i.e., query generator) may generate and send queries to state database 220 (see 460 in FIG. 4). The queries may be associated with T₁, T₂ and possibly other state table(s). A consistency check may be performed to determine whether there is any state inconsistency between T₁ and T₂ (see 470 in FIG. 4). Any desired state inconsistency or inconsistencies may be identified. Using T₁ as a source of truth for the desired state, the state inconsistency may include missing information and/or stale information in T₂ when compared to T₁. Alternatively, T₂ may serve as a source of truth for the realized state to detect any state inconsistency in T₁ when compared to T₂.

Results of the consistency check may be utilized to generate remediation action(s) to be dispatched and applied to the corresponding controller 410 and/or forwarder 42m. For example, in response to determination that there is a state inconsistency, remediation dispatcher 212 may perform remediation action(s) by dispatching instruction(s), such as to implement the desired state, to remediation unit 44m associated with the relevant forwarder 41m. See 480 and 48m for 1≤m≤M. Using examples of the present disclosure, any state inconsistency between multiple planes (e.g., control plane and data plane) may be detected, and remediation action(s) performed in real time. Examples of the present disclosure may improve debuggability for state inconsistency issues because users may be prompted to collect debugging information timely when discrepancy begins to manifest.

Example Detailed Process and Formulations

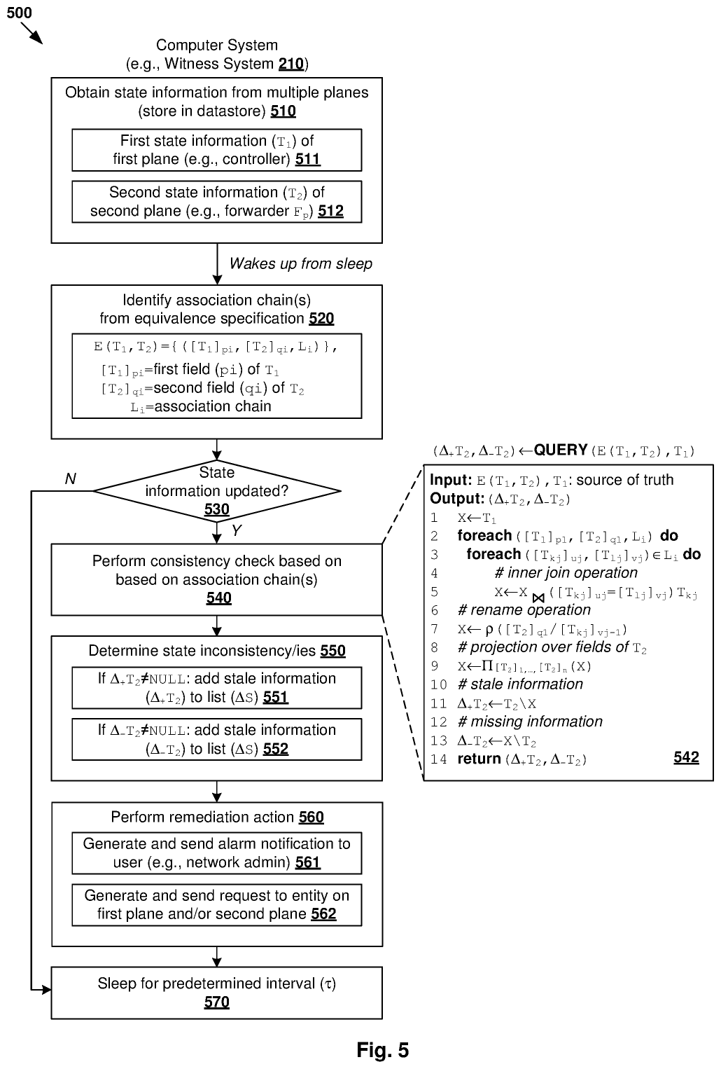

FIG. 5 is a flowchart of example detailed process 500 for a first computer system to perform state consistency monitoring in a network environment. Example process 500 may include one or more operations, functions, or actions illustrated by one or more blocks, such as 510 to 570. Depending on the desired implementation, various blocks may be combined into fewer blocks, divided into additional blocks, and/or eliminated.

(a) State Information

At 510 in FIG. 5, witness system 210 may obtain state information (see 450-450M in FIG. 4) associated with respective controller 410 and M forwarders 421-42M. Here, the term “obtain” may refer to witness system 210 receiving state information 450-450M from state collector 411/43m and/or retrieving state information 450-450M from state database 220, where m∈[1, . . . , M]. In practice, state information may be implementation-specific and heterogenous. In general, however, state information may be modeled as a set of state tables according to Definition 1 below.

Definition 1: A state domain D=(L, ⊥, T, [symbol] ) is a semilattice over a set of values L where [symbol] is the partial order over L, ⊥, T∈L such that ∀l∈L and ⊥ [symbol] l [symbol] T. Here, T denotes ‘ANY’ and ⊥ denotes ‘NIL’ or ‘NULL.’ A state table T over state domains D₁, . . . , Dₙ is defined as T⊆D₁× . . . ×Dₙ. [T]ᵢ (where 1≤i≤n) denotes the i^{th} column or field of T. The notation D_{[T]}_{ᵢ} may be used to denote the state domain of [T]ᵢ. For a tuple t=(d₁, . . . , dₙ)∈T, [T]ᵢ(t) may denote the i^{th} component of t. Note that each column of a state table is subject to a state domain. For example, when the type of column/field is integer, the column/field is subject to the set of integers plus T (i.e., ANY) and ⊥ (i.e., NULL).

Depending on the desired implementation, only a fragment of state information may be required to be modeled into state tables according to the requirement of state consistency monitoring. The schemas of state tables are predefined. Each state table has primary key set on one or multiple fields and no foreign key is set because referential integrity is not required for state tables.

For controller (C) 410, first state information 450 may be formulated as S₁=set of state tables (each denoted as T₁) that are stored in state database 220 of witness system 210. Similarly, for forwarder (Fₘ) 42m, second state information 45m may be formulated as S_{F}_{ₘ}=set of state tables (each denoted as T₂(Fₘ)) that are stored in state database 220. S₁ may be updated by controller 410, and S_{F}_{ₘ} by the m^{th} forwarder 42m with composed query statements for state information changes, such as adding a new entry, removing or updating an entry from a state table (e.g., T₁∈S₁ or T₂∈S_{F}_{ₘ}), etc.

For each table T₁, there may be a column/field of forwarder identifier as part of the primary key, which may be leveraged to filter the states to be enforced to specific forwarders. When a new configuration arrives at controller (C) 410, records with proper forwarder identifiers may be inserted into a state table according to the span of this configuration. For each n-ary state table T∈S_{F}_{ₘ} or S₁, we have ∀t∈T. [T]ᵢ(t)≠⊥ for 1≤i≤n, which implies that no null value is included in any record of state tables.

(b) Association Chain(s)

At 520 in FIG. 5, witness system 210 may identify association chain(s) associating (a) first state information 450 with (b) second state information 45m. For simplicity, a pair of state tables may be denoted as (T₁, T₂), where T₁ is associated with controller 410, and T₂=T₂(Fₘ) with forwarder 42m in the example in FIG. 4. To facilitate formal discussion, auxiliary concepts may be defined as follows.

Definition 2: Given state tables T₁, . . . , Tₖ, an association chain denoted as [symbol] ([T₁]ₚ₁, [T₂]_{q2}), ([T₂]ₚ₂, [T₃]_{q3}), . . . ([Tₖ₋₁]ₚₖ₋₁, [Tₖ]_{qk}) [symbol] may be defined for ([T₁]ₚ₁, [Tₖ]_{qk}) where domain

$${D}_{{[ {T}_{i} ]}_{pi}} = {D}_{{[ {T}_{i + 1} ]}_{qi + 1}}$$

for 1≤i<k. L defines a relation R_{L} over D_{[T}_{₁}_{]}_{ₚ₁}×D_{[T}_{ₖ}_{]}_{_{qk}}. d₁₁, dₖₖ∈R_{L} if and only if ∃t₁∈T₁, . . . , tₖ∈Tₖ, such that:
(1) [T₁]ₚ₁(t₁)=d₁₁ and [Tₖ]_{qk}(tₖ)=dₖₖ; and
(2) [Tᵢ]ₚᵢ(tᵢ)=[Tᵢ₊₁]_{qi+1}(tᵢ₊₁) for 1≤i≤k.

More generally, the association between [T₁]ₚ₁ and [Tₖ]_{qk} may be formulated into a graph. For simplicity, all associations between table fields may be regarded as linear chains. The following procedures and conclusions may be generalized for non-linear associations.

Definition 3: Given two state tables T₁ and T₂, an equivalence target for (T₁, T₂) may be denoted as ([T₁]ₚᵢ, [T₂]_{qi}, Lᵢ), where Lᵢ=association chain for fields [T₁]ₚᵢ and [T₂]_{qi} in respective state tables. An equivalence specification E(T₁,T₂) may be defined as a set of equivalence targets for (T₁, T₂). Using E(T₁,T₂)={([T₁]ₚᵢ, [T₂]_{qi},Lᵢ)} for 1≤i≤k, state tables T₁ and T₂ may satisfy the equivalence specification if the following conditions are satisfied:
(1) ∀t₁∈T₁ and ∃t₂∈T₂, ([T₁]ₚᵢ(t₁), [T₂]_{qi}(t₂))∈R_{L}_{ᵢ} for each 1≤i≤k; and
(2) ∀t₂∈T₂ and ∃t₁∈T₁, ([T₁]ₚᵢ(t₁), [T₂]_{qi}(t₂))∈R_{L}_{ᵢ} for each 1≤i≤k.

According to definition 2, an association chain may be defined for checking the consistency of two tables that do not have common fields but are associated with other state table(s). For example, consider table T_{A} with fields=(P, Q) and table T_{B} with fields=(R, S) that are associated with table C with fields=(Q, R) according to association chain L=<([T_{A}]_{Q}, [T_{C}]_{Q}), ([T_{C}]_{R}, [T_{B}]_{R})>. The association chain defines a binary relation between [T_{A}]_{Q} and [T_{B}]_{R} via intermediate fields [T_{C}]_{Q} and [T_{C}]_{R}. Based on statement (1) in definition 1, when (x, y) is in this binary relation, x is in [T_{A}]_{Q} and y in [T_{B}]_{R}. Based on statement (2), there is an entry (t_{A}) from table T_{A}, an entry (t_{B}) from table T_{B} and an entry (t_{C}) from table T_{C} such that (a) the field of Q of t_{A} is equivalent to the field of Q of t_{C}, and (b) the field of R of t_{C} equals to the field R of t_{B}.

According to definition 3, an equivalence target gives that two table fields should be consistent over a given association chain. Continuing from the above example with association chain L=<([T_{A}]_{Q}, [T_{C}]_{Q}), ([T_{C}]_{R}, [T_{B}]_{R})>, T_{A} and T_{B} satisfy equivalence target E(T_{A}, T_{B})=([T_{A}]_{Q}, [T_{B}]_{R}, L) provided conditions (1) and (2) are satisfied. Based on condition (1), for an arbitrary value x in [T_{A}]_{Q}, there is a value y in [T_{B}]_{R} such that (x, y) is in a binary relation defined by the association chain. Based on condition (2), there is a value x in [T_{A}]_{Q} such that (x, y) is in the binary relation defined by the association chain.

Consider an example with two state tables T₁, T₂∈D₁×D₂ that do not satisfy an equivalence target. For example, T₁={(d₁₁, d₂₁), (d₁₂, d₂₂)} and T₂={(d₁, d₂₁), (d₁₂, d₂₃)} where (d₁₁, d₁₂) are distinct elements in D₁ and (d₂₁, d₂₂, d₂₃) are distinct elements in D₂. In this case, equivalence specification E(T₁,T₂) may include two equivalence targets in the form of ([T₁]₁, [T₂]₁, [symbol] [T₁]₁, [T₂]₁ [symbol] ) and ([T₁]₂, [T₂]₂, [symbol] [T₁]₂, [T₂]₂ [symbol] ). By definition, T₁ and T₂ do not satisfy E(T₁,T₂) because (1) for (d₁₂, d₂₂)∈T₁, [symbol] t₂∈T₂ such that d₁₂=[T₂]₁(t₂) and d₂₂=[T₂]₂(t₂); and (2) for (d₁₂, d₂₃)∈T₂, [symbol] t₁∈T₁ such that d₁₂=[T₁]₁(t₁) and d₂₃=[T₁]₂(t₁).

(c) Database Queries

At 530, 540 and 550 in FIG. 5, in response to determination that state information 450/45m has been updated since the previous cycle (e.g., by querying transaction history associated with datastore 220), witness system 210 may compare (T₁, T₂) based on equivalence information E(T₁, T₂) by generating query or queries to state database 210. If there has been no change, state consistency checking may be skipped because state updates are expected to converge prior to checking. In this case, witness system 210 proceeds to block 570 where it may sleep for a predetermined interval (τ), which may be configured to be no less that the maximum expected time cost for state enforcement.

Without loss of generality, let T₁ and T₂ be the respective state tables for controller (C) 410 and a particular forwarder 42m. State consistency monitoring may involve querying state database 220 to perform a consistency check by comparing first field(s) in T₁ with second field(s) in T₂. The consistency check is performed to determine whether there is at least one state inconsistency between multiple planes. For example, using T₁ as the source of truth, a state inconsistency may be stale information (denoted as Δ₊T₁) or missing information (denoted as Δ₋T₂) in T₂.

At 542 in FIG. 5, an example procedure of database query performed by query generator 211 denoted as QUERY(E(T₁, T₂), T₁) is provided. Without loss of generality, let inputs to the procedure include E(T₁,T₂)=equivalence specification and T₁=source of truth. The output(s) of the procedure may include stale information (Δ₊T₂) and/or missing information (Δ₋T₂) in T₂ The idea of deriving the stale/missing information is to derive a table X with columns/fields of T₂ such that each record of X has a corresponding record in T₁ with respect to E(T₁,T₂), and then compare X with T₂. At line 5, inner join operation(s) may be utilized to derive X based on the theorem below.

Theorem: Given state tables (T₁, . . . , Tₖ) and association chain L= [symbol] ([T₁]ₚ₁, [Tₖ₁]ᵤ₁), ([Tₖ₁]ᵥ₁, [Tₖ₂]ᵥ₂), . . . , ([Tₖⱼ₋₁]ᵤⱼ₋₁, [Tₖⱼ]ᵥⱼ₋₁) ([Tₖⱼ]ᵤⱼ, [T₂]_{q1}) [symbol] that defines an equivalence target ([T₁]ₚ₁, [T₂]_{q2}, L). For t₁∈T₁ and tₖ∈Tₖ, consider two following statements. A first statement (denoted P) is: T*=T₁ [symbol] _{[T}_{₁}_{]}_{ₚᵢ}_{=[T}_{₂}_{]}_{_{q2}} T₂ . . . Tₖ₋₁ [symbol] _{[T}_{ₖ₋₁}_{]}_{ₚₖ₋₁}_{=[T}_{ₖ}_{]}_{_{qk}} Tₖ, and ∃t*∈T* such that [T*]_{[T}_{₁}_{]}_{ₚ₁}(t*)=[T₁]ₚ₁(t₁) and [T*]_{[T}_{ₖ}_{]}_{_{qk}}(t*) [Tₖ]_{qk}(tₖ). A second statement (denoted Q) is: ([T₁]ₚ₁(t₁), [Tₖ]_{qk}(tₖ))∈R_{L}. In this case, P⇔Q. In other words, by performing an inner join (denoted as [symbol] ) over multiple state tables with respect to the association chain, a binary relation defined by the association chain may be derived.

In relational database, an inner join operation may refer to the joining of multiple tables to create a new table that have matching values in the multiple tables. After performing the inner join operation(s), X has the same columns of T₁, T₂ and possibly other tables involved in the association chain(s). Next, at line 7, a rename operation may be performed to rename [Tₖⱼ]ᵥⱼ₋₁ as [T₂]_{q1} based on the association chain (Lᵢ). The result of the rename operation may be projected on the columns/fields of T₂ such that the projected table is ready for comparison with T₂. This way, a state inconsistency (if any) may be identified at line 11 (i.e., stale information) and line 13 (i.e., missing information) of the query procedure (see 542 in FIG. 5).

(d) State Inconsistencies

In more detail, at 550 in FIG. 5, witness system 210 may determine whether there is at least one state inconsistency based on the consistency check using the query procedure at 542 in FIG. 5. For example, at 551, in response to detecting stale information (i.e., Δ₊T₂ is non-empty) in T₂, the stale information and associated Fₘ (i.e., Δ₊Tⱼ, Fₘ) may be stored in a list (ΔS) for generating and sending remediation request(s) to Fₘ. Alternatively or additionally, at 552, in response to detecting missing information (i.e., Δ₋T₂ is non-empty) in T₂, the stale information and associated Fₘ (i.e., Δ₋Tⱼ, Fₘ) may be stored in a state inconsistency list (ΔS) for generating and sending remediation request(s) to relevant forwarder Fₘ. Once added to the list (ΔS), the detected state inconsistency may be queued for generating remediation.

Consider an example with two state tables T₁, T₂∈D₁×D₂, where T₁={(d₁₁, d₂₁), (d₁₂, d₂₂)}, T₂={(d₁₁, d₂₁), (d₁₂, d₂₃)}. Here, (d₁₁, d₁₂) are distinct elements in D₁ and (d₂₁, d₂₂, d₂₃) are distinct elements in D₂. In this case, equivalence specification E(T₁, T₂) may include ([T₁]₁, [T₂]₁, [symbol] [T₁]₁, [T₂]₁ [symbol] ) and ([T₁]₂, [T₂]₂, [symbol] [T₁]₂, [T₂]₂ [symbol] ). Let (Δ₊T₂, Δ₋T₂) be the output of a database query procedure QUERY(E(T₁, T₂), T₁). In this case, stale information Δ₊T₂={(d₁₂, d₂₃)} and missing information Δ₋T₂={(d₁₂, d₂₂)} may be detected.

Using QUERY(E(T₁,T₂), T₁) at 542 in FIG. 5, there may exist t₁∈T₁ such that t₁∉Π_{[T}_{₁}_{]}_{₁}_{, . . . , [T}_{₁}_{]}_{ₘ}(T₁′) where T₁′ is the resultant table after inner join operations. This implies that t₁ is not involved in consistency checking, which is reasonable because t₁ may not be enforced without knowing how to convert t₁ to record(s) in T₂ (i.e., realized form of t₁).

(d) Remediation Action(s)

At 560 in FIG. 5, after traversal of each association chain identifiable from the equivalence specification, witness system 210 may perform remediation action(s) based on the state inconsistency list (ΔS), such as using remediation dispatcher 212 to (a) notify a user (e.g., network administrator) of any state inconsistency and/or (b) dispatch remediation request(s) to controller (C) 410 and/or forwarder (Fₘ) 42m. At 570, witness system 210 then sleeps for a predetermined interval (τ) until the next cycle.

For stale information (Δ₊T₂), remediation dispatcher 212 may generate and send a request to remediation unit 44m of forwarder (Fₘ) 42m to address the state inconsistency, such as by updating its state information to remove the stale information. For missing information (Δ₋T₂), remediation dispatcher 212 may generate and send a request to remediation unit 44m of associated forwarder (Fₘ) 42m to add the missing information. The remediation request(s) may be implementation-specific, such as updating configuration store, invoking input/output control (ioctl) command(s) to kernel, etc. Specific sequences on applying remediation for different state tables may be required subject to the dependencies of state tables.

Depending on the desired implementation, a user may be notified of any state inconsistency via an alarm, Simple Network Management Protocol (SNMP) trap, email bot etc. The remediation request(s) may be dispatched to the relevant network entity or entities to apply remediation automatically. Any other remediation action(s) may be performed, such as executing a runbook that diagnoses certain unhealthy symptoms, generating a log bundle immediately when the system is still in a problematic state, etc. The user may be asked to determine appropriate action(s) to taken, such as whether to apply the remediation automatically, whether to execute the runbook, whether to generate the log bundle, etc.

At 570 in FIG. 5, witness system 210 may sleep for a predetermined interval (t) before the next working cycle. In practice, the interval may be configurable by a user (e.g., network administrator). Depending on the desired implementation, the interval should be no less than a maximum realization time for any configuration by design. Otherwise, false alarms may be raised by normal configuration realization.

### First Example: Logical Switch Configuration

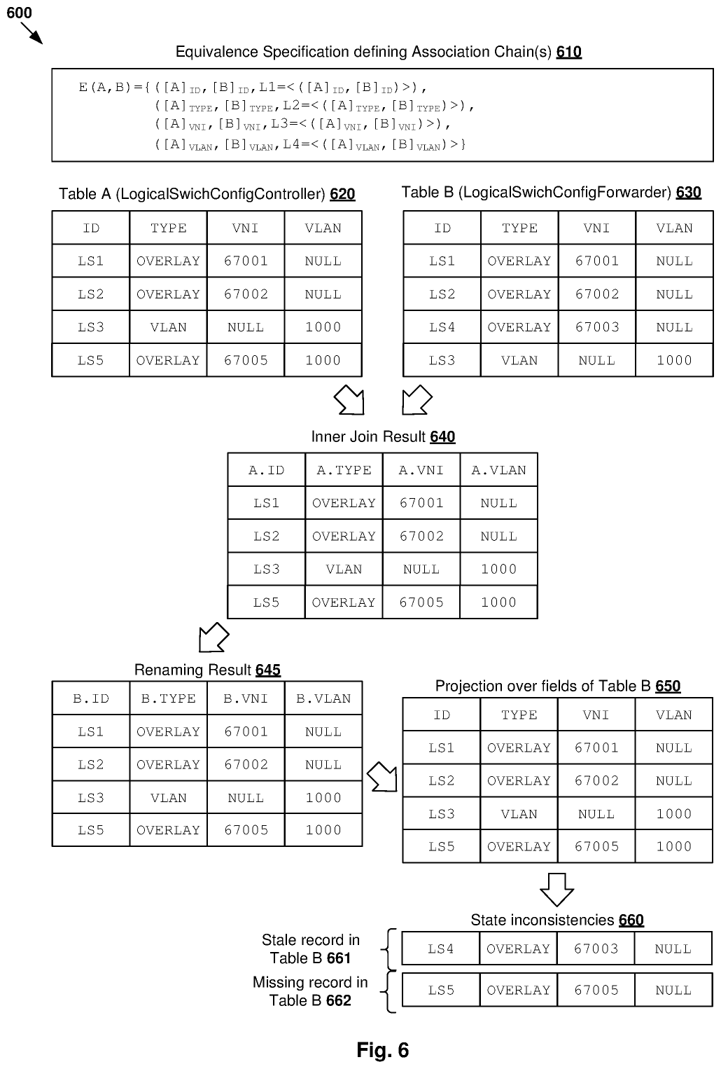

FIG. 6 is a schematic diagram illustrating first example 600 of state consistency monitoring. In this example, witness system 210 may perform a consistency check based on (a) first state information from controller (C) 410 relating to desired states of logical switch configuration and (b) second state information from forwarder (Fₘ) 42m (1≤m≤M) relating to realized states of logical switch configuration. As discussed using FIG. 1, logical switches that provide logical layer-2 connectivity may be implemented collectively by virtual switches 115A-C and represented internally using forwarding tables 116A-C at respective hosts 110A-C.

Using the example in FIG. 5, the first state information obtained at block 510 may include table A (see 620) with fields=(ID, TYPE, VNI, VLAN). The second state information may include table B (see 630) having the same fields. Controller (C) 410 may own table A (LogicalSwitchConfigController) in datastore 220 to store the desired states of logical switch configuration to be enforced on forwarder (Fₘ) 42m. Forwarder (Fₘ) 42m may own table B (LogicalSwitchConfigForwarder) in datastore 220 for the logical switch configuration with the same schema. When controller (C) 410 pushes a new logical switch configuration to forwarder (Fₘ) 42m, controller (C) 410 sends a query to witness system 210 to update table A, such as “INSERT INTO A (ID, TYPE, VNI) VALUES (‘LS5’, ‘OVERLAY’, ‘67005’, ‘1000’).” See last entry in table A.

At 610 in FIG. 6, multiple association chains (L1 to L4) may be identified from an equivalence specification denoted as E(A,B), which defines the specification for a state consistency check. E(A,B) specifies a set of equivalence targets. A first equivalence target specifies a first association chain L1=<([A]_{ID}, [B]_{ID})> that associates (a) field=ID of table A with (b) field=ID of table B. A second equivalence target specifies a second association chain L2=<([A]_{TYPE}, [B]_{TYPE})> that associates (a) field=TYPE of table A with (b) field=TYPE of table B. Similarly, third and fourth equivalence targets may specify respective association chains L3=<([A]_{VNI}, [B]_{VNI})> and L4=<([A]_{VLAN}, [B]_{VLAN})> for the remaining fields VNI and VLAN. Based on E(A,B), witness system 210 (e.g., consistency check unit 211) may query datastore 220 to retrieve table A (see 620) and table B (see 630).

At 640, 645 and 650 in FIG. 6, a consistency check may be performed to compare multiple fields of table A with multiple fields of table B based on association chains L1 to L4. The consistency check may include an inner join operation to generate inner join result 640, which includes fields (A.ID, A.TYPE, A.VNI, A.VLAN) from table A. Next, a rename operation may be performed to rename fields (A.ID, A.TYPE, A.VNI, A.VLAN) in inner join result 640 as (B.ID, B.TYPE, B.VNI, B.VLAN) based on the association chains (L1-L4). Renaming result 645 is projected over the fields of table B to generate a projected table (see 650) for comparison with table B. Each record in projected table 650 has a corresponding record in table A.

At 660 in FIG. 6, witness system 210 may determine whether there is at least one state inconsistency between using table A as the source of truth. Using set minus operation(s) to compare projected table 650 with table B, two state inconsistencies may be identified. At 661, witness system 210 may detect first state inconsistency=stale record that is included in table B, but not included in table A. At 662, witness system 210 may detect second state inconsistency=missing record that is not included in table B, but included in table A.

Based on the result of the state consistency check, witness system 210 may perform any suitable remediation action(s) to address state inconsistencies 661-662. In practice, a remediation action to address a state inconsistency (e.g., add missing information or remove stale information) may be performed in an implementation-specific manner, such as updating configuration store, invoking ioctl command to kernel space, etc. Specific sequences on applying remediation for different state tables may be required subject to the dependencies of state tables.

In the example in FIG. 6, controller (C) 410 may be SDN controller 184 residing on CCP 202 in FIG. 2, while forwarder (Fₘ) 42m may be a transport node (e.g., host-A 110A) residing on DP 204. In this case, the remediation action to address state inconsistency relating to logical switch configuration on the transport node may involve witness system 210 generating and sending a remediation request to the transport node. For example, this may involve issuing a remote procedure call (RPC) to the transport node to involve NestDB CLI command to delete stale logical configuration record 661 and add missing record 662.

In practice, witness system 210 may generate and send a notification to a user (e.g., network administrator) to raise alarm about any state inconsistency detected. Depending on the desired implementation, the remediation request may be sent to the relevant network entity after obtaining the user's approval. The latter approach may reduce the likelihood of any undesirable side effects caused by the remediation request. In this case, the user has opportunity to approve or reject the suggested remediation request based on their review.

### Second Example: Bidirectional Forwarding Direction (BFD) Session

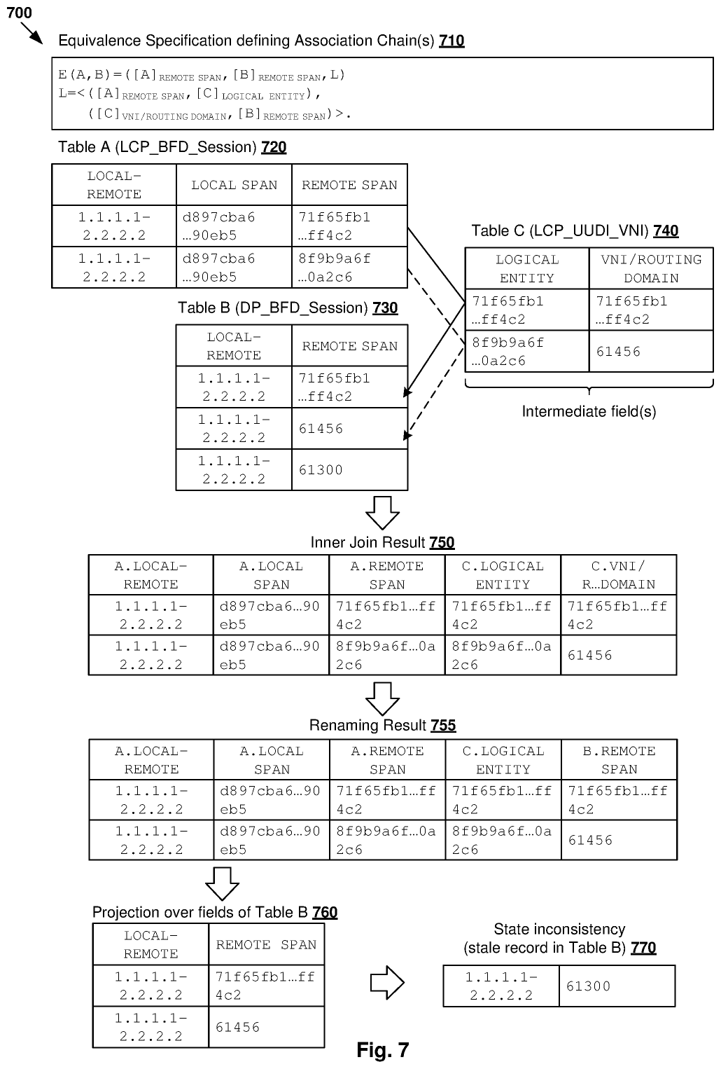

FIG. 7 is a schematic diagram illustrating second example 700 of state consistency monitoring. In practice, a BFD session may be established between a pair of endpoints to monitor a path connecting them, such as for failure detection purposes. The first state information may be obtained from LCP 203 (e.g., LCP agent 119A on host-A 110A) and second state information from DP 204 (e.g., DP entity 205A in FIG. 2, or forwarder 42m in FIG. 5) according to block 510 in FIG. 5.

The first state information from LCP 203 may include table A (see 720) with fields=(LOCAL-REMOTE, LOCAL SPAN, REMOTE SPAN). Here, the “LOCAL-REMOTE” field may specify IP addresses of respective local and remote VTEPs. The “LOCAL SPAN” and “REMOTE SPAN” fields may each specify a universal unique identifier (UUID) of either a logical switch or routing domain. For example, when (local span=S1, remote span=S2), S1 and S2 may communicate via a logical overlay tunnel that is established between a pair of local and remote IP addresses in the “LOCAL-REMOTE” field.

The second state information from DP 204 may include table B (see 730) with fields=(LOCAL-REMOTE, REMOTE SPAN). Similarly, the “LOCAL-REMOTE” field may specify IP addresses of respective local and remote VTEPs. The “REMOTE SPAN” field may denote the VNI of a logical switch or routing domain that uses the VTEP specified by a remote IP address in the “LOCAL-REMOTE” field for overlay networking. During state consistency monitoring, witness system 210 may check the consistency of the “REMOTE SPAN” field in tables A and B. However, it is not possible to perform the check directly because DP 204 uses VNI to represent a logical switch in its “REMOTE SPAN” field, whereas LCP 203 uses the UUID of a logical switch.

At 710 in FIG. 7, to facilitate a consistency check, an association chain may be used to associate [A]_{REMOTE SPAN} with [B]_{REMOTE SPAN} via multiple intermediate fields in table C (see 740) that maps logical switch UUID to VNI. The association chain (L) may be identified from an equivalence specification denoted as E(A,B)=<([A]_{REMOTE SPAN}, [B]_{REMOTE SPAN}, L)>. Here, L=<([A]_{REMOTE SPAN}, [C]_{LOGICAL ENTITY}), ([C]_{VNI/ROUTING DOMAIN}, [B]_{REMOTE SPAN})> that specifies a relationship between (a) field=REMOTE SPAN of table A and (b) field=REMOTE SPAN of table B via (c) multiple intermediate fields=LOGICAL ENTITY and VNI/ROUTING DOMAIN of table C.

At 750, 755 and 760 in FIG. 7, a consistency check may be performed to compare multiple fields of table A with multiple fields of table B based on association chain L. The consistency check may include an inner join operation to generate inner join result 750, which includes fields from tables A and C. Next, a rename operation may be performed to rename field “C.VNI/ROUTING DOMAIN” in inner join result 750 as “B.REMOTE SPAN” based on the association chain (L). Renaming result 755 is projected over the fields of table B to generate a projected table (see 760) for comparison with table B. Each record in projected table 760 has a corresponding record in table A.

At 770 in FIG. 7, witness system 210 may determine whether there is a state inconsistency between using table A from LCP 203 as the source of truth. Using set minus operation(s) to compare projected table 760 with table B, a state inconsistency in the form of a stale record in table B, but not in table A. In this case, a remediation action may be performed by generating and sending (a) an alarm notification to a user and/or (b) a remediation request to a relevant network entity residing on LCP 203 and/or DP 204 to address the state inconsistency.

Experimental Evaluation

A prototype has been developed to evaluate state consistency monitoring according to examples of the present disclosure, such as to check the consistency of desired states related to L2 networking between LCP 203 and DP 204. Using the prototype, the following research questions (RQs) are considered: (RQ1) how effective and efficient does the prototype identify and fix state consistency issues, and (RQ2) what is the overhead introduced by the prototype?

To answer RQ1, the prototype may be evaluated with (a) an artificial benchmark and (b) a real-world benchmark. The artificial benchmark may be generated by a script that randomly adds/removes one or more configurations (e.g., in a vdl2 kernel module associated with DP 204) and then checks whether the consistency is restored within a specified timeout. For the real-world benchmark, the prototype may be evaluated with two state inconsistency situations caused by two product issues. To answer RQ2, the CPU and memory usages of host may be computed in the cases where state consistency check is enabled or disabled, with respect to logical topologies of different scales.

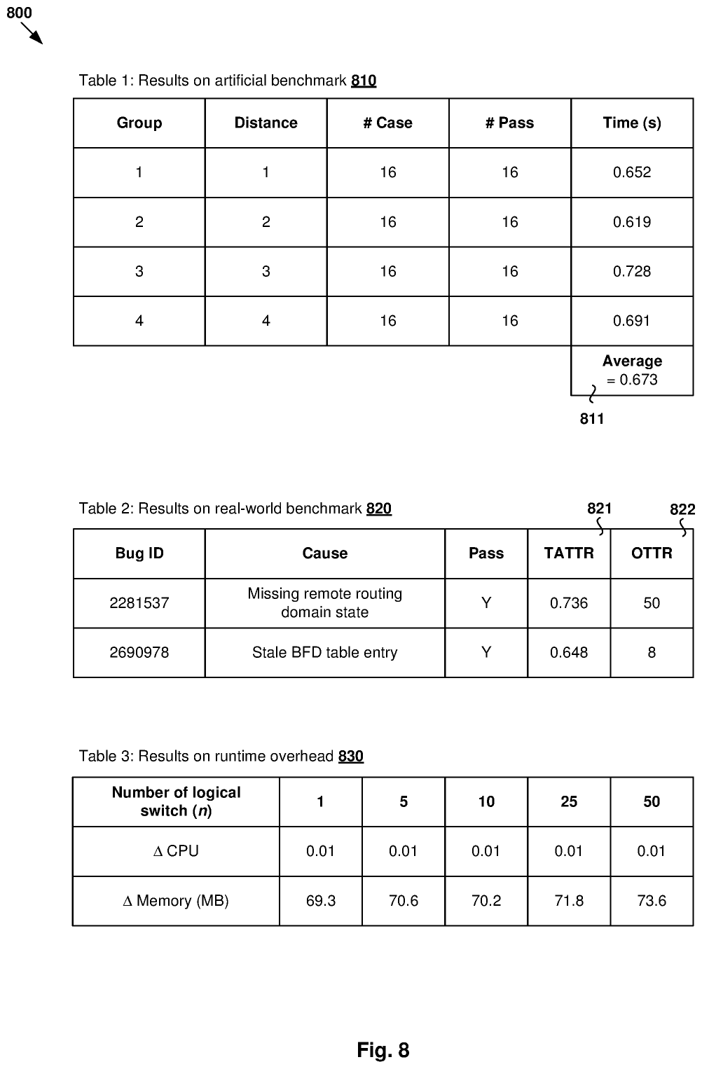

Some examples will be discussed using FIG. 8, which is a diagram illustrating experimental evaluation results associated with state consistency monitoring. FIG. 8 shows table 1: results on artificial benchmark (see 810), table 2: results on real-world benchmark (see 820) and table 3: results on runtime overhead (see 830). The prototype may include any suitable components, including an agent (e.g., nsx-cfagent) implementing functionalities of LCP 203 and a kernel module (e.g., vdl2 kernel module) implementing functionalities of DP 204, a state information database, and component(s) to query the database and perform remediation action(s). The experiments are conducted on two Dell PowerEdge R640 servers with Intel® Xeon® Gold 5120@2.20 GHz, 200 GB memory and installed with VMware ESXi™ 7.0.1. VMs are deployed with a TCLinux template which has one vCPU and 128 MB memory space. The interval for consistency checking is 10 s.

(a) States of Interests

The following desired states related to L2 networking are considered: (1) logical switch definition (which includes properties of a logical switch, such as name, replication mode, VNI and routing domain ID), (2) remote logical switch state (which includes MAC/IP information of connected vNICs and VTEPs chosen by the certain logical switch in a remote host), (3) remote routing domain state (which includes VTEPs chosen by the certain routing domain in a remote host), (4) BFD table (which includes pairs of local and remote VTEPs to have overlay tunnels established, and references of each tunnel by local/remote logical switches/routing domains). The equivalence specification is defined for the consistency of remote logical switch states, remote routing domain states and BFD tables between LCP and DP. The source of truth is on LCP. All the involved associations of table fields may be linear.

(b) Remediation

Any remediation on the remote state of logical switch or routing domain may be applied prior to the re-mediation on BFD table when they are in the same batch because updating BFD table requires correct information on remote logical switches and routing domains.

(c) Artificial Benchmark

The testing script has three variable parameters: the number of test cases, the edit distance (which refers to the number of added/removed configurations from vdl2 kernel module for each case) and the timeout for the restoration of consistency. 4 groups of experiments are designed for edit distances 1-4, while the number of test cases is set to 16 and the timeout is set to 100 s for all the groups. Each case may involve mixed stale and missing configurations in the vdl2 kernel module. Between two adjacent cases, the script sleeps for 50 s to make sure the configuration convergences before the subsequent case starts. If one case fails, the remaining cases in the group will be skipped because state consistency is required prior to each test run. For this experiment, each server has 6 VMs deployed and every two connect to one logical switch, and all 3 logical switches are connected to one TO logical router.

The results are listed in Table 1 (see 810 in FIG. 8). All the cases in 4 groups with different edit distances are passed. The column “Time” refers to the average duration from the beginning of the first consistency checking cycle since the occurrence of discrepancy to the completion of remediation for passed cases in each group. The time cost of remediation is 0.673 s on average (see 811) and has no statistically significant relevance between the edit distance and average time cost. That said, edit distance is not the key factor for the time cost of remediation given the same logical topology and user configurations.

(d) Real-World Benchmark

Two product issues listed in Table 2 (see 820 in FIG. 8) are chosen to evaluate the prototype. Bug 2281537 is related to missing of a remote routing domain VTEP, and Bug 2690978 is related to stale BFD session entries. For each issue, a special build of the agent (e.g., nsx-cfgagent mentioned above) may be used without the fix for the respective original issue and deploy an appropriate logical topology (which is not necessarily the one that the original bug report used) to manifest the issue while consistency checking is disabled. Upon enablement of consistency checking, it is observed whether the issue is remediated and measure the duration from the beginning of the first consistency checking cycle to the completion of remediation.

As Table 2 in FIG. 8 shows, the prototype succeeds in remediating two issues. The time cost of remediation (see TATTR 821) is less than 1 second for each issue, while the original time to resolution (see OTTR 822) is 8-50 days. Here, column “TATTR” 821 specifies a tool-assisted time to resolution associated with each bug. Column “OTTR” 822 specifies the time cost on resolving a bug since its filing.

(e) Runtime Overhead

Runtime overhead may be measured by comparing average CPU/memory metrics in 5 minutes (e.g., using esx top utility) when state consistency monitoring is enabled or disabled on all components. The experiment is conducted using an example topology where (1) there are n (e.g., n=1, 5, 10, 25, 50) logical switches connected to one TO logical router; (2) each server has 2n VMs deployed and every two connect to one logical switch.

Table 3 (see 830 in FIG. 8) shows the runtime overhead results. The overhead in terms of overall CPU load is about 0.01 which is not sensitive to the number of logical switch (n). This is because the increase of state information caused by more logical switches does not introduce substantial CPU cycles in state database query. For memory metrics, on one hand memory footprint generally grows when logical switch number increases due to more state data, on the other hand the overhead (69.3 MB-73.6 MB) is mostly contributed by the inherent factors such as SQLite connections and the consistency checking plugin itself.

(d) Threat to Validity

First, the overhead on consistency checking generally grows over the increase of states, state tables and equivalence targets. The experiment data does not provide much insight on this aspect because the prototype only supports consistency checking between LCP and DP with respect to a limited kind of states. One candidate solution to this challenge is to leverage multiple workers in witness system 210 to perform consistency checking in parallel. Second, remediation may have non-negligible latency when the whole system is in an unstable or overloaded state. If the remediation is not realized within a predetermined interval (τ), the unremedied discrepancy may still be captured by the next working cycle.

Container Implementation

Although discussed using VMs 131-136, it should be understood that state consistency monitoring may be performed for other virtualized computing instances, such as containers, etc. The term “container” (also known as “container instance”) is used generally to describe an application that is encapsulated with all its dependencies (e.g., binaries, libraries, etc.). For example, multiple containers may be executed as isolated processes inside VM1 131, where a different VNIC is configured for each container. Each container is “OS-less”, meaning that it does not include any OS that could weigh 11s of Gigabytes (GB). This makes containers more lightweight, portable, efficient and suitable for delivery into an isolated OS environment. Running containers inside a VM (known as “containers-on-virtual-machine” approach) not only leverages the benefits of container technologies but also that of virtualization technologies.

Computer System

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform processes described herein with reference to FIG. 1 to FIG. 8. For example, a computer system capable of acting as “witness system” may be deployed in SDN environment 100 to perform examples of the present disclosure.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described or can be alternatively located in one or more devices different from that in the examples. The units in the examples described can be combined into one module or further divided into a plurality of sub-units.

1. A method for a computer system to perform state consistency monitoring in a network environment that includes a first plane and a second plane, wherein the method comprises:
identifying one or more association chains that associate (a) first state information of one or more first network entities residing on the first plane with (b) second state information of one or more second network entities residing on the second plane, wherein the first plane and the second plane are different planes;
based on the one or more association chains, performing a consistency check to compare multiple first fields of the first state information with multiple second fields of the second state information;
based on the consistency check, determining whether there is a state inconsistency between the first plane and the second plane; and
in response to determination that there is a state inconsistency, performing a remediation action to address the state inconsistency by generating and sending at least one of the following: a notification to a user, and a remediation request to a particular first network entity residing on the first plane or a particular second network entity residing on the second plane.

2. The method of claim 1, wherein determining whether there is a state inconsistency comprises:
using the first state information as a source of truth, identifying the state inconsistency in the form of stale information that is included in the second state information but not in the first state information.

3. The method of claim 1, wherein determining whether there is a state inconsistency comprises:
using the first state information as a source of truth, identifying the state inconsistency in the form of missing information that is included in the first state information but not in the second state information.

4. The method of claim 1, wherein performing the consistency check comprises:
performing an inner join operation between the first state information and the second state information using the first state information as a source of truth.

5. The method of claim 4, wherein performing the consistency check comprises:
performing a rename operation to rename one or more fields in a result of the inner join operation;
generating a projected table by projecting a result of the rename operation over the multiple second fields of the second state information; and
comparing the projected table with the second state information.

6. The method of claim 1, wherein identifying the one or more association chains comprises:
identifying a particular association chain from an equivalence specification that includes a set of equivalence targets, wherein each equivalence target specifies (a) a particular first field of the first state information, (b) a particular second field of the second state information, and (c) the particular association chain that associates the particular first field with the particular second field via zero or more intermediate fields.

7. The method of claim 1, wherein determining whether there is a state inconsistency comprises:
determining whether there is a state inconsistency between the first plane and the second plane, wherein the first plane and the second plane are selected from the following: management plane, control plane, local control plane and data plane.

8. A non-transitory computer-readable storage medium that includes a set of instructions which, in response to execution by a processor of a computer system, cause the processor to perform state consistency monitoring, wherein the method comprises:
identifying one or more association chains that associate (a) first state information of one or more first network entities residing on the first plane with (b) second state information of one or more second network entities residing on the second plane, wherein the first plane and the second plane are different planes;
based on the one or more association chains, performing a consistency check to compare multiple first fields of the first state information with multiple second fields of the second state information;
based on the consistency check, determining whether there is a state inconsistency between the first plane and the second plane; and
in response to determination that there is a state inconsistency, performing a remediation action to address the state inconsistency by generating and sending at least one of the following: a notification to a user, and a remediation request to a particular first network entity residing on the first plane or a particular second network entity residing on the second plane.

9. The non-transitory computer-readable storage medium of claim 8, wherein determining whether there is a state inconsistency comprises:
using the first state information as a source of truth, identifying the state inconsistency in the form of stale information that is included in the second state information but not in the first state information.

10. The non-transitory computer-readable storage medium of claim 8, wherein determining whether there is a state inconsistency comprises:
using the first state information as a source of truth, identifying the state inconsistency in the form of missing information that is included in the first state information but not in the second state information.

11. The non-transitory computer-readable storage medium of claim 8, wherein performing the consistency check comprises:
performing an inner join operation between the first state information and the second state information using the first state information as a source of truth.

12. The non-transitory computer-readable storage medium of claim 11, wherein performing the consistency check comprises:
performing a rename operation to rename one or more fields in a result of the inner join operation;
generating a projected table by projecting a result of the rename operation over the multiple second fields of the second state information; and
comparing the projected table with the second state information.

13. The non-transitory computer-readable storage medium of claim 8, wherein identifying the one or more association chains comprises:
identifying a particular association chain from an equivalence specification that includes a set of equivalence targets, wherein each equivalence target specifies (a) a particular first field of the first state information, (b) a particular second field of the second state information, and (c) the particular association chain that associates the particular first field with the particular second field via zero or more intermediate fields.

14. The non-transitory computer-readable storage medium of claim 8, wherein determining whether there is a state inconsistency comprises:
determining whether there is a state inconsistency between the first plane and the second plane, wherein the first plane and the second plane are selected from the following: management plane, control plane, local control plane and data plane.

15. A computer system, comprising (a) a datastore, (b) a consistency check unit and (c) a remediation dispatcher, wherein:
(a) the datastore is to store first state information of one or more first network entities residing on the first plane and second state information of one or more second network entities residing on the second plane, wherein the first plane and the second plane are different planes;
(b) the consistency check unit is to perform the following:
identify one or more association chains that associate the first state information with the second state information;
based on the one or more association chains, perform a consistency check to compare multiple first fields of the first state information with multiple second fields of the second state information; and
based on the consistency check, determine whether there is a state inconsistency between the first plane and the second plane; and
(c) the remediation dispatcher is to, in response to determination that there is a state inconsistency, perform a remediation action to address the state inconsistency by generating and sending at least one of the following: a notification to a user, and a remediation request to a particular first network entity residing on the first plane or a particular second network entity residing on the second plane.

16. The computer system of claim 15, wherein the consistency check unit is to determine whether there is a state inconsistency by performing the following:
using the first state information as a source of truth, identify the state inconsistency in the form of stale information that is included in the second state information but not in the first state information.

17. The computer system of claim 15, wherein the consistency check unit is to determine whether there is a state inconsistency by performing the following:
using the first state information as a source of truth, identify the state inconsistency in the form of missing information that is included in the first state information but not in the second state information.

18. The computer system of claim 15, wherein the consistency check unit is to perform performing the consistency check by performing the following:
perform an inner join operation between the first state information and the second state information using the first state information as a source of truth.

19. The computer system of claim 18, wherein the consistency check unit is to perform the consistency check by performing the following:
perform a rename operation to rename one or more fields in a result of the inner join operation;
generate a projected table by projecting a result of the rename operation over the multiple second fields of the second state information; and
compare the projected table with the second state information.

20. The computer system of claim 15, wherein the consistency check unit is to identify the one or more association chains by performing the following:
identify a particular association chain from an equivalence specification that includes a set of equivalence targets, wherein each equivalence target specifies (a) a particular first field of the first state information, (b) a particular second field of the second state information, and (c) the particular association chain that associates the particular first field with the particular second field via zero or more intermediate fields.

21. The computer system of claim 15, wherein the consistency check unit is to determine whether there is a state inconsistency by performing the following:
determine whether there is a state inconsistency between the first plane and the second plane, wherein the first plane and the second plane are selected from the following: management plane, control plane, local control plane and data plane.
